(19) United States
(12) Patent Application Publication
(10) Pub. No.: US 2012/0005902 A1
(43) Pub. Date: Jan. 12, 2012

(54) WIRE CUTTER HEAD FOR PREVENTING MISALIGNMENT OF THE CUTTING BLADES

(75) Inventor: Chen-Sheng Yang, Changhua City (TW)

(73) Assignee: FIST WAY INDUSTRIAL CO., LTD., CHANGHUA CITY (TW)

(21) Appl. No.: 12/832,065

(22) Filed: Jul. 8, 2010

(51) Int. Cl. B26B 13/00

(52) U.S. Cl. 30/252

(57) ABSTRACT

A wire cutter head for preventing misalignment of cutting blades comprises two cutting members, the two cutting members respectively have a cutting face and a handle neck at two ends and are pivoted together at a middle position. The cutting face is a stepped inclined surface having a stopping surface formed with an inclined angle at an approximant middle section, such that the two stopping surfaces are flat with respect to each other, and a blade is formed at a lower edge of the cutting face. The handle neck is a plate used for controlling the pivot angle of the cutting blades. When the handle necks of the cutting members are pressed to rotate the cutting faces, the two facing stopping surfaces and the blades of the two cutting members contact each other. Therefore, the linear contact between the blades is free from misalignment and no offset gap between the blades occurs during operation.

### BACKGROUND OF THE INVENTION

1. Field of the Invention

The present invention relates to a wire cutter head for preventing misalignment of the cutting blades, and more particularly to a wire cutter head that is able to prevent misalignment and avoid damage and wearing of the blades.

2. Description of the Related Art

Currently, typical wire cutter heads have the structure as shown in FIGS. 6, 7 and 8, and comprise two cutting members 70. Each cutting member has a cutting face 71 and a handle neck 72 extending from the two respective ends. The two cutting members 70 are pivoted together at a center position, and each cutting face 71 has a blade 711 along an edge. Both of two handle necks 72 are coupled to an elastic member 721 to be forced opened after being pressed together. When the handle necks 72 of the cutting members 70 are placed under stress, the cutting faces rotate to cause the two blades to meet each other to cut objects. The two blades 711 have a line of contact with each other, and therefore, sometimes slipping may occur due to the small area to which the cutting force is applied; the blades 711 may thus become damaged and suffer from wear, which can lead to misalignment of the blades 711.

Therefore, it is desirable to provide an improved wire cutter head to mitigate and/or obviate the aforementioned problems.

### SUMMARY OF THE INVENTION

An objective of the present invention is to provide a wire cutter head for preventing misalignment of the cutting blades.

In order to achieve the above-mentioned objectives, the wire cutter head for preventing misalignment of the cutting blades includes two cutting members, the two cutting members having a cutting face and a handle neck respectively at two ends and pivoted together at a middle position. When the handle necks of the cutting members are pressed to rotate the cutting faces, the two facing stopping surfaces and the blades of the two cutting members contact each other. Since the two facing stopping surfaces each has an entire flat face that comes into contact with the other, the linear contact between the blades is free from misalignment and no offset gap between the blades occurs during operation.

With the above-mentioned structure, the following benefits can be obtained: when the cutting head is utilized for cutting objects, the stopping surfaces of two cutting members have their entire faces coming into contact with each other; and the linear contact between the blades is free from misalignment and no offsetting gap is created between the blades when in use. Therefore, a tool having the wire cutter head is capable of being used on small objects while making a smooth cut.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is a local detailed view of a stopping surface and a blade according to an embodiment of the present invention.

FIG. 3 is a front view of an embodiment of the present invention.

FIG. 4 is a horizontal cross-sectional view along a line A-A according to an embodiment of the present invention.

FIG. 5 is a schematic drawing of an elastic member according to an embodiment of the present invention.

FIG. 6 is a perspective view of a prior art.

FIG. 7 is a front view of the prior art.

FIG. 8 is a horizontal cross-section view of the prior art along a line B-B.

### DETAILED DESCRIPTION OF THE PREFERRED EMBODIMENT

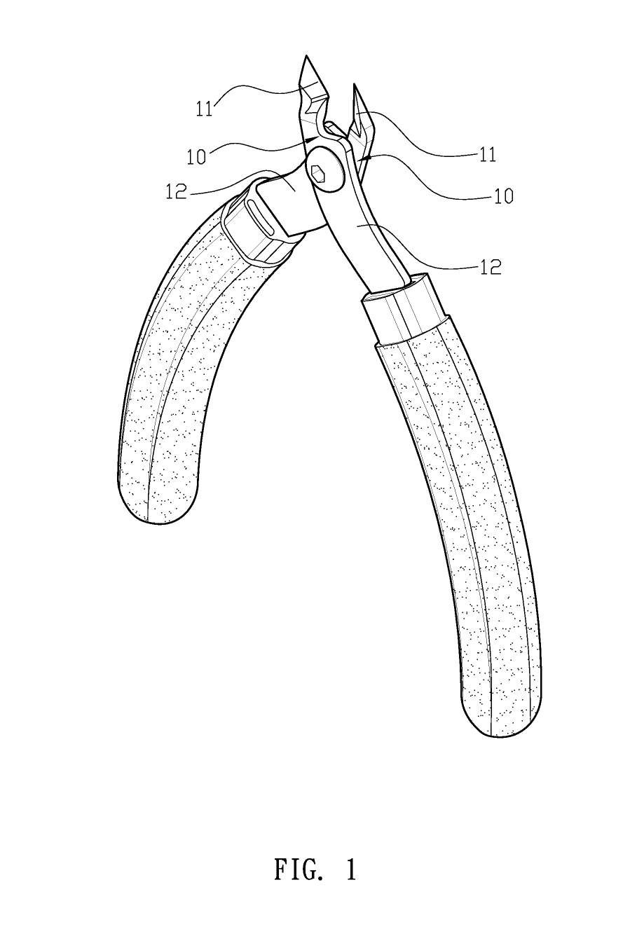

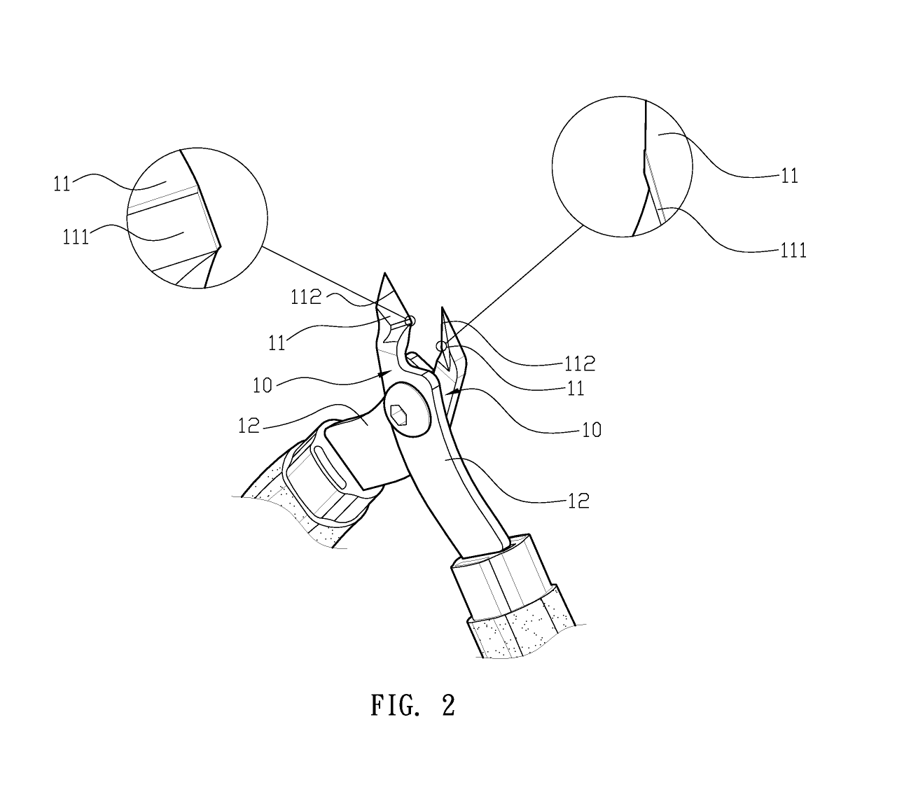

First, please refer to FIG. 1 and FIG. 2. FIG. 1 is a perspective view of an embodiment of the present invention. FIG. 2 is a local detailed view of a stopping surface and a blade according to an embodiment of the present invention. A wire cutter head for preventing misalignment of cutting blades comprises two cutting members 10; the two cutting members 10 each has a cutting face 11 and a handle neck 12 respectively at two ends and are pivoted together at their middle positions. Each cutting face 11 is a stepped inclined surface having a stopping surface 111 formed with an inclined angle at an approximant middle section, such that the two stopping surfaces 111 are flat, and a blade 112 is formed along a lower edge of the cutting face 11. The handle neck 12 is a plate used for controlling the pivoting angle.

For assembly, please refer again to FIGS. 1 and 2. The two cutting members 10 are overlapped with each other and pivoted together at the middle section such that the two cutting members 10 can be rotated with respect to each other. The cutting members 10 employ the blades 112 of the cutting faces 11 and the movements of the handle necks 12 to cut objects.

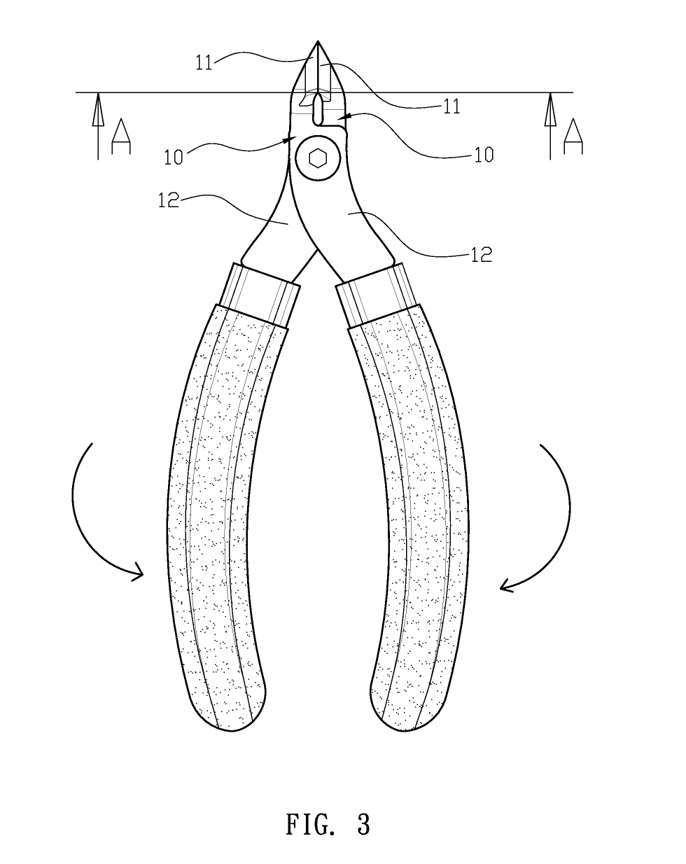

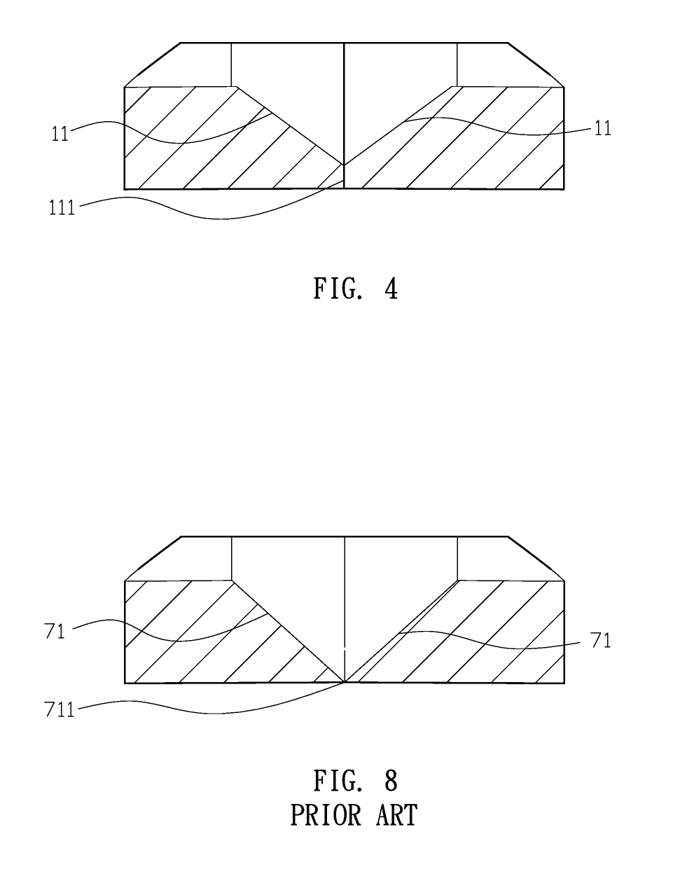

For operational movements, please refer to FIGS. 3 and 4. When the handle necks 12 of the cutting members 10 are pressed to rotate the cutting faces 11, the two facing stopping surfaces 111 and the blades 112 of the two cutting members 11 contact each other. Since the two facing stopping surfaces 111 each has an entire flat face that comes into contact with the other, the linear contact between the blades 112 is free from misalignment and no offset gap between the blades 112 occurs during operation.

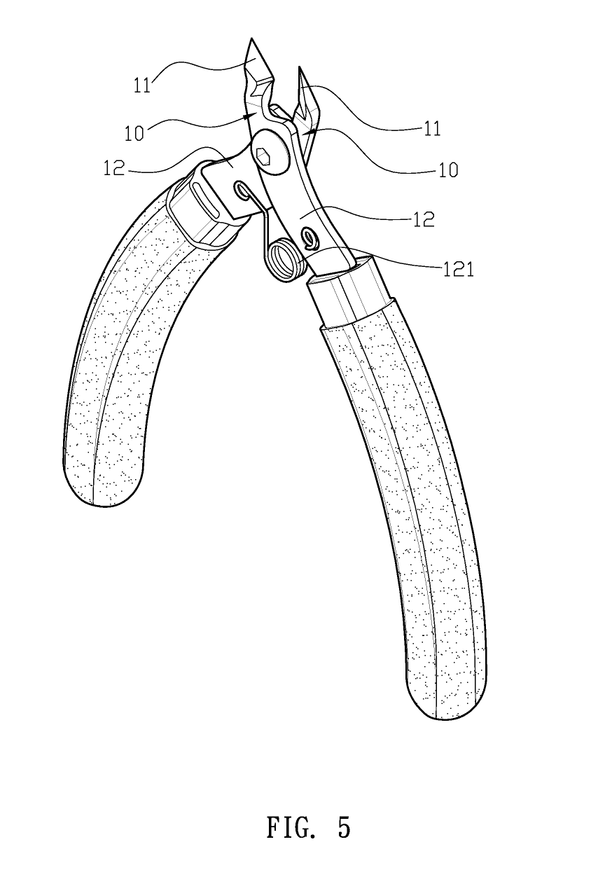

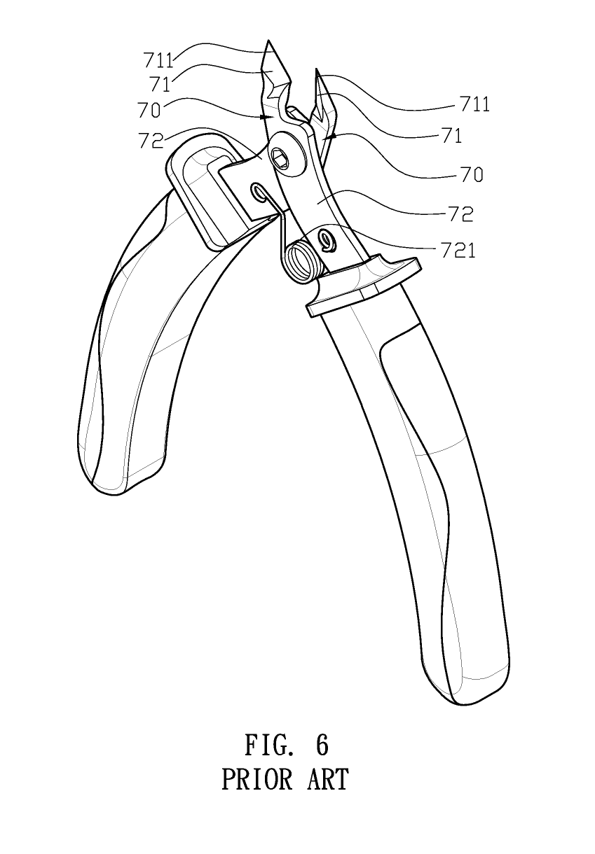

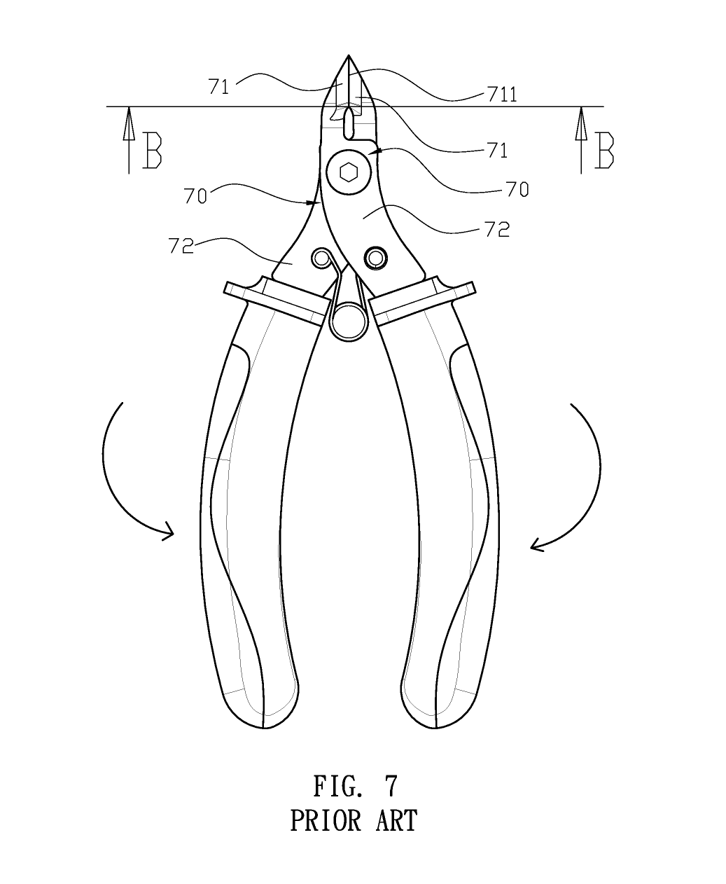

For another embodiment, please refer to FIG. 5. The handle necks 12 of the two cutting members 10 are respectively connected to an elastic member 121, and the elastic member 121 is a torsion spring which provides a return bias to the handle neck 12.

With the above-mentioned structure, the following benefits can be obtained: when the cutting head is utilized for cutting objects, the stopping surface 111 of two cutting members 10 have their entire faces coming into contact with each other; and the linear contact between the blades 112 is free from misalignment and no offsetting gap is created between the blades 112 when in use. Therefore, the tool with the wire cutter head is capable of being operated on small objects while making a smooth cut.

Although the present invention has been explained in relation to its preferred embodiment, it is to be understood that many other possible modifications and variations can be made without departing from the spirit and scope of the invention as hereinafter claimed.

What is claimed is:

1. A wire cutter head for preventing misalignment of cutting blades comprising two cutting members, the two cutting members respectively having a cutting face and a handle neck at two ends and pivoted together at a middle position, the handle neck being a plate used for controlling a pivot angle; the wire cutter head characterized in that:
the cutting face is a stepped inclined surface having a stopping surface formed with an inclined angle at an approximant middle section, such that the two stopping surfaces are flat, and a blade is formed at a lower edge of the cutting face;
wherein when the handle neck of the cutting member is pressed to rotate the cutting faces such that the two facing stopping surfaces and the blades of two cutting members contact each other.

2. The wire cutter head for preventing misalignment of cutting blades wherein the handle neck of the two cutting members are both connected to an elastic member, and the elastic member can be a torsion spring.
